(19) United States
(12) Patent Application Publication
(10) Pub. No.: US 2016/0136642 A1
(43) Pub. Date: May 19, 2016

(54) A Microfluidic Device with Pillars

(71) Applicant: DANMARKS TEKNISKE UNIVERSITET, Lyngby (DK)

(72) Inventors: Johan Eriksen, Frederiksberg (DK); Rudolphe Marie, Copenhagen V. (DK); Anders Kristensen, Frederiksberg C (DK)

(21) Appl. No.: 14/899,981

(22) PCT Filed: Jun. 30, 2014
(86) PCT No.: PCT/EP2014/063824

§ 371 Date: Dec. 18, 2015

(30) Foreign Application Priority Data
Jun. 28, 2013 (EP) 13174382.5

(51) Int. Cl. B01L 3/00

(52) U.S. Cl. CPC B01L 3/502715; B01L 2200/10; B01L 2300/0851; B01L 2200/027; B01L 2200/0636; B01L 2300/165; B01L 2300/12; B01L 2200/12

(57) ABSTRACT

The invention provides a microfluidic device for mixing liquid reagents, the device comprises, a chip forming at least one reaction chamber between a bottom and a top and extending between an inlet and an outlet. To enable manufacturing from less rigid materials, the device comprises pillars extending from the bottom to the top. The invention further provides a method of mixing reagents by use of the device.

### INTRODUCTION

The present invention relates to a microfluidic device e.g. for mixing liquid reagents. Particularly, the invention relates to a device comprising a chip forming at least one reaction chamber between a bottom and a top. The reaction chamber extends between an inlet for receiving the reagent and an outlet for discharging the reagent thereby forming a straight-line flow path in the chamber in a direction from the inlet to the outlet. The invention further relates to a method of mixing liquid reagents by use of the device.

### BACKGROUND

Sequential addition of liquid reagents is used for example in DNA amplification by extraction of DNA from a sample.

So called Lab-on-a-chip (LOC) technology today provides the sensitivity required to analyse single cells. This technology is typically applied where single-cell analysis should be streamlined or automated to provide a high-throughput.

The term chip when used herein, relates to the down-scaling the laboratory to one single and very small element compared with a laboratory in traditional sense. Typically, the overall size is in the mm to cm regime. This has several advantages including for example less reagent volume, less reaction time, integrated processes, and the option to use the LOC for new applications. The term chip should therefore not be confused with the traditional silicon chip consisting of integrated electrical circuit.

A microfluidic device is known e.g. from EP0843734 which discloses fluid samples which are moved from one reaction chamber to another chamber via fluid channels by applying a positive pressure differential from the originating chamber.

On-chip amplification of DNA is used for many purposes. A common amplification technique is the polymerase chain reaction, PCR which is a method for producing a large number of copies of a certain DNA fragment. While the purpose of PCR is to amplify only a fragment of the DNA, another technique for amplification of DNA is the multiple displacement amplification, MDA. Contrary to PCR, MDA amplifies the entire DNA genome. The protocol has most recently been used in a microfluidic device for amplifying DNA from single cells.

Since the first development of the LOC concept in the 1980's there has been significant improvements in functionality and fabrication techniques. However, miniaturization and commercialization of the LOC devices have been delayed e.g. due to the lack of integration of vital components such as micro pumps and micro valves.

The LOC devices can be divided into three main categories: glass devices, polymer devices, and silicon devices. Silicon LOC devices originated as a path dependency from the known IC fabrication techniques whereas the glass devices are favourable because of the knowledge in relation to biochemical interaction. However, the machining and design possibilities are very limited compared with the polymer devices, which were developed more recently. The different fabrication techniques such as injection moulding, laser machining and embossing are all applicable in the production of polymer devices. LOC devices are single use disposable devices that can be mass produced and they are therefore primarily made from polymer materials by injection moulding.

Since polymer materials are typically less rigid than e.g. silicon materials, the material properties restrict the ability to freely design different shapes.

### DESCRIPTION OF THE INVENTION

To enable a simple chip structure e.g. for use in DNA amplification and particularly for use in MDA, and particularly to reduce manufacturing costs, the invention provides a microfluidic device comprising a plurality of adjacent pillars, where each pillar forms its own axial direction extending from the bottom to the top, and where each pillar is separated from adjacent pillars by open slots.

Accordingly, the pillars may increase the rigidity and thus prevent or reduce deflection of the top or bottom wall and prevent chamber collapse.

Due to the pillars, the chip may be manufactured from less rigid materials, e.g. by injection moulding of polymer materials, e.g. thermoplastic materials. This may not only lower the manufacturing costs for making the chip, but it may also enable a smaller chip structure with space for more chambers within a chip of a specific size. More specifically, it may enable relatively wide chambers with long distances between the side walls.

For the purpose of mixing the liquid reagents, a change in the flow direction of the reagent away from the straight direction from the inlet to the outlet may be desirable. For this purpose, the pillars may particularly be arranged to form at least one row extending in a row-direction which may particularly be transverse to the straight-line path from the inlet to the outlet. The row-direction may e.g. be perpendicular to the straight-line path.

Herein, the straight-line flow path is defined as a path in the direction along the shortest possible line from the inlet to the outlet.

By arranging the pillars in rows, the rows may provide phase guiding of the liquid reagents. I.e. the meniscus of the liquid may follow the rows instead of following the more natural direct way from the inlet to the outlet.

Molecules at an interface of a liquid will be in a higher energy state due to missing neighbours resulting in surface tension. This is given by Gibbs energy, G, per area, A

The fluid will always minimize the energy by minimizing the surface area—also when a pressure is applied to the reaction chamber and the fluid fills the chamber. The fluid will be pinched between the pillars, and when these are arranged in rows or in a rectangular lattice or in other patterns, the change in curvature of the interface per filled volume will be at a minimum when the fluid are filling the chamber along a row of pillars since the fluid will be pinched between two adjacent pillars.

Due to the applied pressure, the fluid begins to wet around the pillars, and forms a characteristic contact angle to the substrate, not counting a change in angle due to applied pressure. The fluid forms an interface to the next pillar first when the fluid from the previous row contacts the propagating interface.

The pillars may form a contact angle of at least 30 degrees, or at least 40 degrees or at least 50 or at least 60 or at least 70 or at least 80 degrees to a fluid containing human DNA, e.g. to a diluted DNA solution containing TBE buffer, BME and Triton.

The pillars may be formed by a polymer material, particularly a polymer material selected from the group consisting of polypropylene, polyethylene, and amorphous polymer cyclic olefin copolymer materials (COC—also called Topas). In this case, the contact angle may particularly be in the range of 35-45 degrees to a fluid containing human DNA or the contact angle may particularly be above 90 degrees to water.

In this embodiment, the pillars and possibly also the bottom and top may preferably be made from one or more materials selected from this group.

Particularly, the pillars could be made from a hydrophobic material, e.g. a material selected from the above group and particularly from a material having a contact angle of at least 35 degrees to a fluid containing human DNA or forming a contact angle above 90 degrees to water.

The pillars in the reaction chamber thereby have two functions, namely that of preventing collapse of the bottom and top and that of providing phase guiding along the row.

Particularly, the device may comprise at least two, e.g. three, four, five, six or more rows of pillars thereby forming an ordered array of pillars.

Adjacent pillars in a row may be spaced at most a first distance, and adjacent rows could be spaced at least a second distance being larger than the first distance. This will create rows of adjacent pillars which may form phase guiding of a meniscus in the reaction chamber back and forth along each adjacent row. In that way, the meniscus may follow the direction of the rows, i.e. the meniscus may follow a flow path comprising flow sections in different directions while the subsequent liquid may be allowed to pass through the spacing between adjacent pillars in a row of pillars and thereby follow the straight-line flow path. As a result, the meniscus and the subsequent flow may obtain different directions whereby the mixing capability of the chamber is increased.

To further increase rigidity and strength of the chip, at least one of the pillars may connect the bottom wall to the top wall of the chamber. The pillars may e.g. be moulded into the bottom and top walls or they could be adhesively bonded thereto.

The slots, in a cross section perpendicular to the axial direction of the pillars, are smaller than the pillars.

The pillars may have a non-circular shape in a cross section perpendicular to the axial direction. Particularly, the pillars may have a shape which includes a sharp edge. As an example, the pillars may have an elliptic shape or an eye-shape, i.e. essentially the shape of a human eye or the shape of a lemon—i.e. a circular shape with at least one sharp pointed edges in a direction, and preferably with two sharp pointed edges in opposite directions

Such shapes may provide an increased guiding effect for the meniscus since it will require a larger surface of the fluid to move around an edge when the edge has a smaller radius—i.e. when the edge is sharp. Accordingly, it will require a larger surface to move around the sharp pointed edge of the pillar

Adjacent pillars may be parallel or non-parallel, and the rows may likewise be parallel or non-parallel. Particularly, the rows may be non-parallel such that the aforementioned flow sections formed by adjacent rows widens out in the direction from the inlet towards the outlet.

It may be an issue to avoid contamination or uncontrolled flow into the reaction chamber. For this reason, it may also be important to avoid or at least restrict the diffusion into the chamber due to the strict stoichiometric MDA protocol.

For this reason, the inlet may be configured to prevent diffusion of macromolecules including genomic DNA and enzymes in or out of the reaction chambers. The inlet may e.g. have a largest dimension in the same order of magnitude as the persistence length of double stranded DNA, e.g. in the order of 10-200 nm such as in the order of 50-100 nm.

The inlet may e.g. be formed as a diffusion barrier, e.g. made as a restriction in the height. The diffusion will be limited due to a restriction dimension of the barrier height.

It may become possible to handle different reagents in the device by applying different diffusion barriers to the device. In one embodiment, different reaction chambers have different diffusion barriers and in another embodiment, the same inlet into one reaction chamber has several different diffusion barriers located one after the other.

In one embodiment, the device comprises a plurality of chambers, e.g. 2, 3, 4, 5 or more chambers sharing a common junction via the micro channels. The chambers could be located in a circular layout, or a star layout about the common junction. In that way, the device takes up less space.

The reaction chambers, the inlets, the outlets, the pillars, and optionally, the common junction and micro channels may be formed in one piece. The device may e.g. include a chip or be constituted by a chip which is moulded, e.g. in one piece, in a polymeric material.

To enable monitoring of the filling of the reaction chamber and mixing in the reaction chambers, the device may have at least one transparent or translucent wall section, e.g. made from a transparent or translucent polymer material or glass, and in one embodiment at least one of the pillars is also from a transparent or translucent material. By transparent or translucent is herein considered that it is able to transmit electromagnetic radiation in the visible wavelength.

In a second aspect, the invention provides a method of mixing liquid reagents by use of a device as described above. The method comprises the steps of providing a flow of the liquid reagents through the reaction chamber, where the flow speed is adjusted such that adjacent rows provides phase guiding of a meniscus of the reagents and such that subsequent flow of the liquid reagents are allowed to pass between adjacent pillars of a row. The method may particularly include the step of allowing the meniscus of the reagent to flow in a row direction along a row of pillars transverse to the straight-line path from the inlet to the outlet and to allow subsequent liquid, i.e. after the meniscus to follow another direction transverse to the row direction. This may increase the mixing of reagents.

The liquid reagent may particularly comprise DNA, e.g. human DNA.

The method may comprise the step of carrying out spectrophotometric analysis of the reagent in the device.

The invention, in a third aspect, provides a method of providing a device according to the first aspect of the invention by injection moulding of a polymer material into a mould which is shaped such that the pillars supports the stability of the device and prevents deflection of the bottom and top towards each other.

### BRIEF DESCRIPTION OF DRAWINGS

In the following, embodiments of the invention will be described by way of example with reference to the figures in which:

FIG. 1 illustrates a chip device according to the invention;

FIG. 2 illustrates schematically two chambers of a device;

FIGS. 3a-3e illustrate the basic function of the device;

FIG. 4 illustrates that the device comprises a plurality of adjacent pillars;

FIGS. 5, 6a, 6b, 6c illustrate pillars for guiding the meniscus transverse to the straight-line path in the chamber;

FIGS. 7a and 7b illustrate fabrication steps;

FIG. 8 illustrates two images of imprints;

FIG. 9a illustrates a microscope image showing an imprint carried out in a CNI tool;

FIG. 9b illustrates a difference in manufacturing time when using different tools;

FIG. 10 relates to an experiment and shows filling of DNA into the device; and

FIGS. 11a and 11b illustrate results from an off-chip amplification and negative control.

### DETAILED DESCRIPTION

Further scope of applicability of the present invention will become apparent from the following detailed description and specific examples. However, it should be understood that the detailed description and specific examples, while indicating preferred embodiments of the invention, are given by way of illustration only, since various changes and modifications within the scope of the invention will become apparent to those skilled in the art from this detailed description.

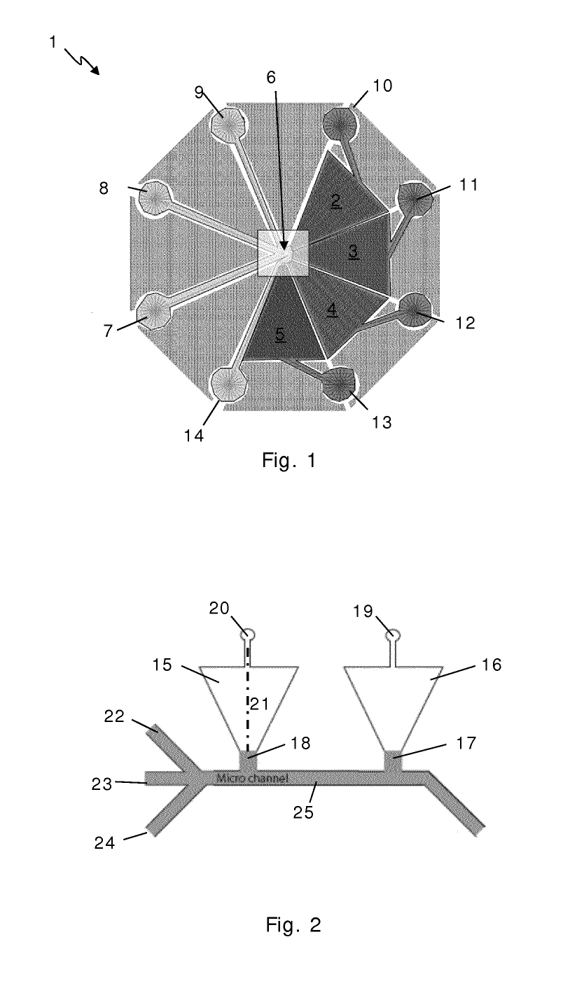

FIG. 1 illustrates a microfluidic device according to the invention. The device comprises a chip 1 forming 4 reaction chambers 2, 3, 4, 5.

Each reaction chamber extends between an inlet which is directly adjacent a common junction 6. The common junction 6 communicates with 3 intakes 7, 8, 9 for receiving different reagents. Each chamber further has an outlet 10, 11, 12, 13 for discharging the mixed reagents.

The chip 1 further forms a waste discharge 14 for discharging reagents which are not received in a chamber.

FIG. 2 illustrates two chambers 15, 16 arranged side by side. Each chamber has an inlet 17, 18 and an outlet 19, 20. In FIG. 2, it is illustrated that each chamber thereby forms a straight-line flow path indicated by the dotted line 21 from the inlet to the outlet.

The liquid reagents are added to the intakes 22, 23, 24 and conducted to the chambers via the common junction 25 by controlling pressure differences at the intakes, and outlets, optionally also at the common junction and/or at the inlets. The inlets comprise diffusion barriers for preventing diffusion of molecules such as DNA molecules.

To control the pressure differences, the chip could be mounted on a chuck with O-rings placed between the chuck and the intakes, outlets and waste discharge to ensure no leakage. Air hoses may connect the chuck to a pressure control device such as MFCS-FLEX, Fluigent where the pressure at a plurality of different channels can be adjusted, individually, independent of each other.

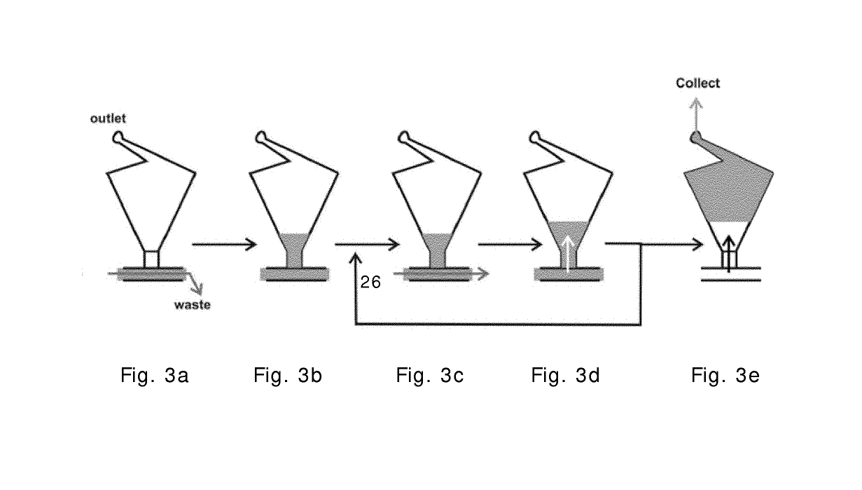

FIGS. 3a-3e illustrate the basic function of the device, i.e. on-chip amplification of DNA. In FIG. 3a, the sample is introduced by a pressure driven flow into the common junction. In FIG. 3b, a finite volume of the sample is, by pressure, introduced into the reaction chamber. In FIG. 3c, a reagent is, by pressure, forced into the bus. In FIG. 3d, a finite volume of the denaturation reagent is filled into the reaction chamber. The arrow 26 indicates that the steps of FIGS. 3c and 3d are repeated in order to firstly introduce neutralisation and, secondly, to introduce the solution which amplifies the sample. In FIG. 3e, the sample is amplified and forced into the outlet and collected e.g. by pipetting.

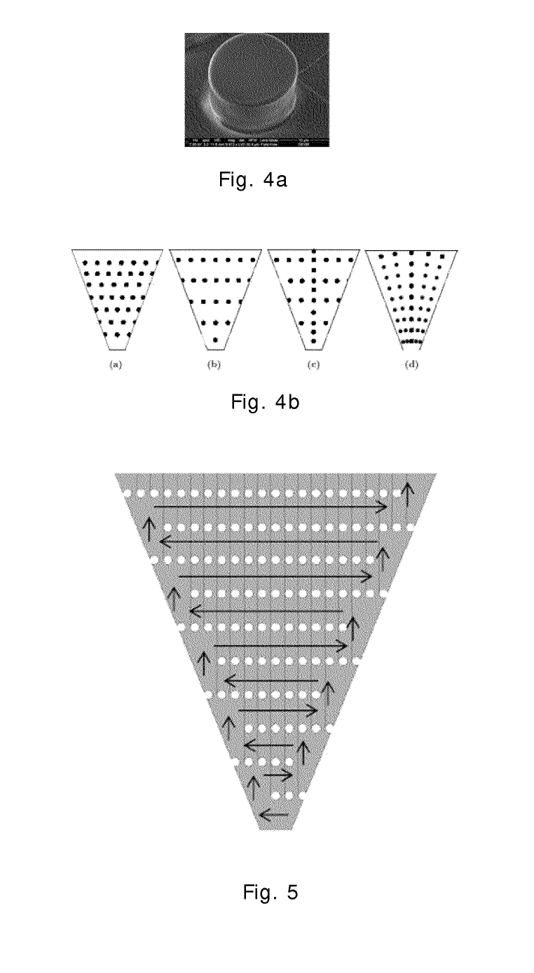

FIG. 4a illustrates a single pillar extending from the bottom of the chip. FIG. 4b illustrates that the device comprises a plurality of adjacent pillars extending from the bottom to the top of the chamber. Each pillar is separated from adjacent pillars by open slots.

The pillars may particularly be arranged in an ordered array which thereby introduces phase guiding of fluid while maintaining a low path length for diffusion, thus ensuring proper mixing in the reaction chamber.

Particularly, FIG. 4 illustrates the four different layouts of the pillars in the reaction chamber. (a) The hexagonal design facilitates a direction independent filling rate. (b) The rectangular arranged pillar design facilitating transverse filling. (c) The rectangular pillar arrangement with a row of pillars in the middle of the chamber and (d) where the distance between the pillars are varied by having a spherical layout.

The fluid will try to minimize the energy by minimizing the surface area. This will occur even when pressure is applied to the reaction chamber and the fluid fills the chamber. The fluid will be pinched between the pillars during filling. Clearly, the distance between the pillars determines the phase guiding, and according to the invention, the device may include a plurality of rows where adjacent pillars in a row are spaced a shorter distance than the shortest spacing between pillars of different rows.

FIG. 5 illustrates a preferred layout of pillars forming rows of adjacent pillars which form phase guiding of a meniscus in the reaction chamber back and forth along each adjacent row, illustrated by the arrows. In that way, the meniscus follow the direction of the rows, namely a flow path comprising flow sections in different directions while the subsequent liquid may be allowed to pass through the spacing between adjacent pillars in a row of pillars and thereby follow the straight-line flow path.

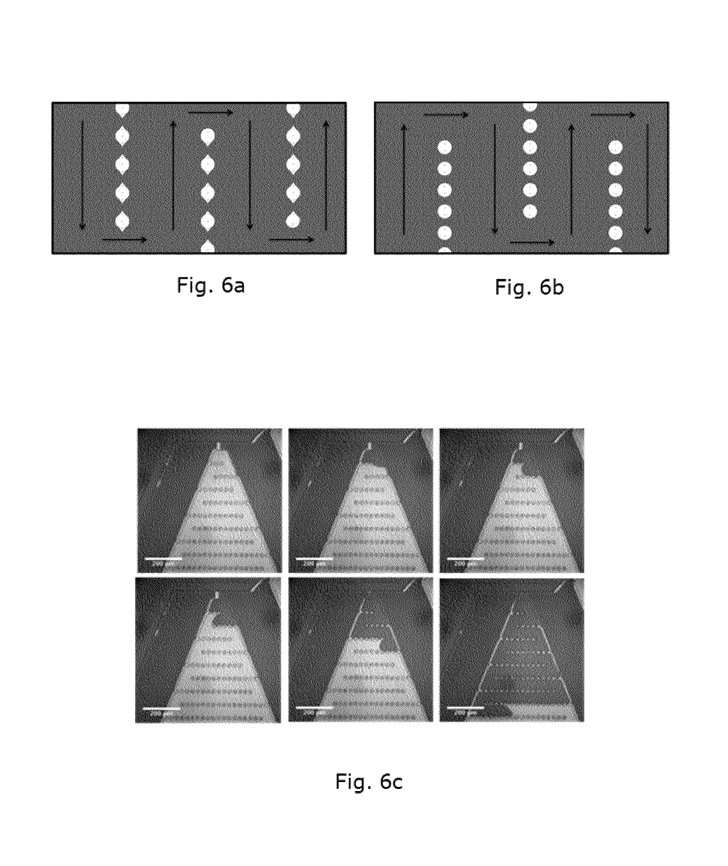

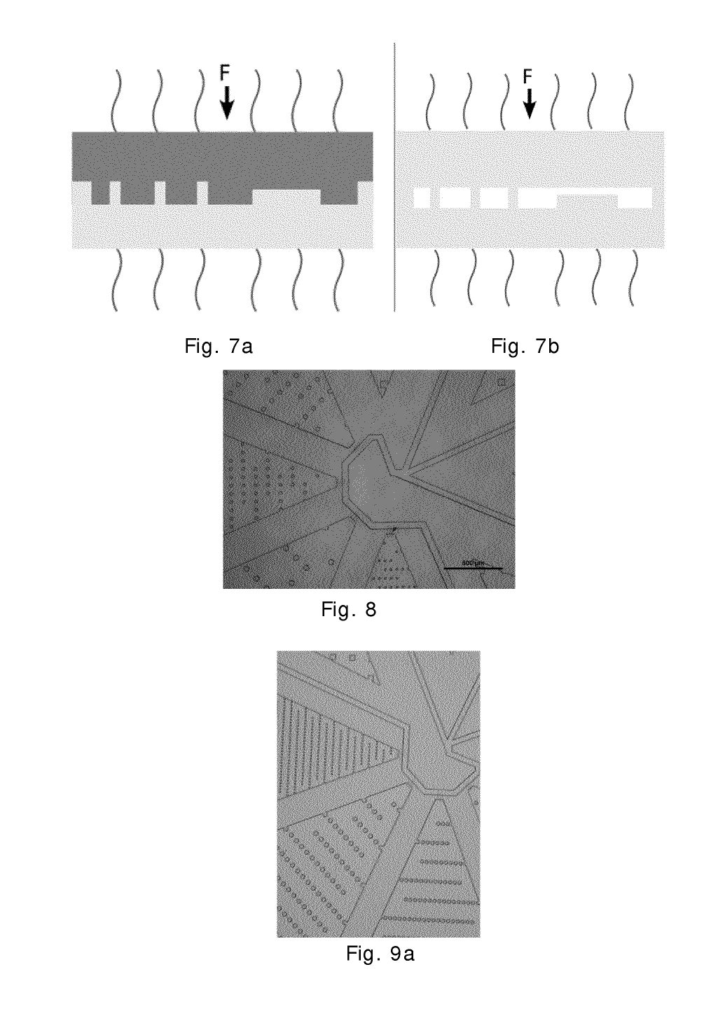

In FIG. 6a, the pillars have a cross sectional shape corresponding to the shape of an eye or a lemon, i.e. a circular shape with two sharp pointed edges in opposite directions. In FIG. 6b, the pillars have a circular cross sectional shape and in FIG. 6c, a photo is taken during an experiment. The photo clearly illustrates the phase guiding.

The chamber including the pillars may be treated with a buffer solution including Triton-X, e.g. in a concentration of 0.001%. This treatment may reduce sticking of the biological material to the surfaces of the device.

The fabrication of the chip may be carried out as a two-step process in which a stamp is firstly thermally imprinted in polymer to achieve the desired form, c.f. FIG. 7a, and subsequently, the structured polymer and a planar polymer sheet are thermally or adhesively bonded c.f. FIG. 7b.

The imprint material could be transparent and should preferably be suitable for imprint. The amorphous polymer cyclic olefin copolymer (COC), also called Topas, is a suitable material for injection moulding.

FIG. 8 illustrates two images of imprint done with an applied pressure of 10 kN, imprint temperature at 190° C. and de-moulding at 70° C. (a) Shows a 10 min imprint where filling of the cavity at the centre is not completed. (b) An imprint time of 20 min shows on the other hand perfect imprint result.

By using a thermal imprint machine in which the thermal mass is relatively low, the imprint protocol may be faster. The imprint could be made e.g. in a dual-use tool designed for optical double-side lithography and precision alignment, e.g. from the company EVG. For wafer sizes up to 150 mm EVG 620 could be used.

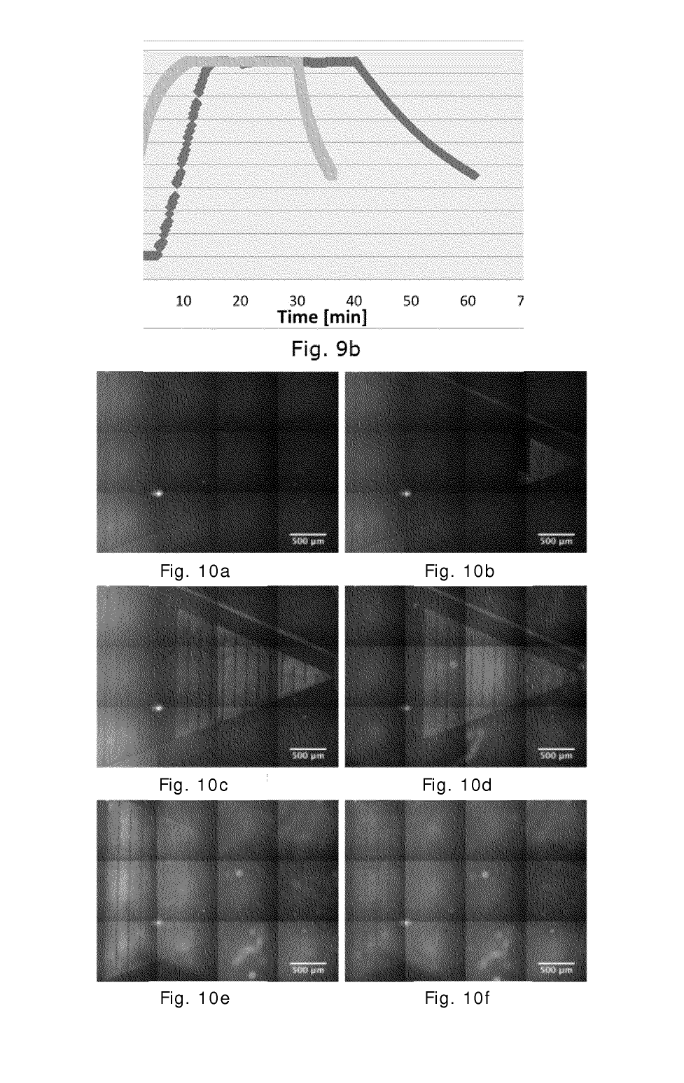

FIG. 9a is a microscope image showing an imprint carried out in CNI. (b)The plot compares the thermal cycle of a 20 min imprint done at 190° C. in an EVG620 tool and CNI tool from a company called NIL Technology. It is seen that by imprinting in the CNI instead of the EVG620 the thermal cycle is reduced to 24 min.

The chambers are located in a circular layout or star layout about a common junction. The inlets are all connected to the common junction via micro channels, and intake leads different reagents to the junction. As previously mentioned, the fluid flow is controlled by pressure differences.

Experiment

A protocol to prevent or minimize DNA to stick to the walls was developed before carrying out the amplification. The first step in the MDA protocol was to introduce the double stranded A-DNA into the chip. This was done by pipetting 5 μl of the diluted DNA solution containing TBE buffer, BME and Triton into the ‘waste’ reservoir. A pressure of 200 mbar was applied to the channel connected to ‘waste’ thus forcing the liquid into the bus and filling all the way to inlet number one, two and three, i.e. to three of the chambers. By doing so, air bubbles were avoided in the bus and the DNA material that was not filled into the reactions chambers was kept in the waste reservoir. During the filling of the bus, a pressure of 400 mbar was applied to the backside of the reaction chambers to ensure that an unwanted burst of sample materials into the reaction chambers would not occur.

The sample containing the DNA was filled into the chamber by applying a pressure to the bus as described in the previous chapter. After bursting into the chamber, the pressure was decreased to avoid a too fast filing rate which would risk unwanted trapping of air bubbles. From the provided protocol is it known that the stoichiometric reaction should be mixed with following volumes: 1:1:2:4

The filling of DNA is shown in FIGS. 10a-10c where an imaging procedure was carried out with 4×3 frames of the chamber. In FIG. 10a time t=0 minutes, temperature is 20° C., in FIG. 10b t=1 min, temperature is 20° C. In FIG. 10c t=15 min, temperature is 20° C., in FIG. 10d t=15 min, temperature is 20° C., in FIG. 10e t=30 min, temperature is 20° C., and in FIG. 10f t=40 min, temperature is 45° C.

The frames were afterwards stitched using MATLAB. A heat cartridge is placed in contact with the chip, c.f. FIG. 10d. This allow for fast and accurate temperature control. It is clear that the background fluorescence changes when the cartridge is placed on the chip. Due to this, it is not possible to subtract the background from the frames.

FIG. 10e shows ⅙ of the reaction chamber filled with the denaturation solution. The DNA was at this stage not denatured, which is seen in the left part of the image.

In FIG. 10f the chip heated to 40° C. and the temperature is increased to 45° C. It is seen that the fluorescence is decreased in the left part of the chamber. This effect occurred instantly but the temperature was held constant for 10 min in order to denature the strands into ssDNA and all base pair bonds broken. Also the fluorescence of YOYO is temperature dependent, thus the chip was cooled down and if the fluorescence intensity stayed low it was concluded that the DNA was denatured.

The next step in the protocol is the neutralization step where a buffer neutralizing the pH is introduced. 0:01% of triton was added to the stop solution and the chamber was filled with a volume of ⅙ of the total volume.

The final step is to measure the concentration of DNA collected from the outlet. This was done by an ethanol precipitation and spectrophotometric measurement.

Due to the very low amount of sample in the reservoir (a volume 5-20%) a low DNA concentration was expected when 5 μl of milliQ water was pipetted into the outlet reservoir and afterwards collected. The sample was according to the protocol heated to 65° C. to inactivate the polymerase. Before measuring the concentration of the amplified sample, an ethanol precipitation was carried out. Ethanol precipitation is a purification tool removing the nucleotides and salt from the sample and an added benefit is an increased concentration of the sample. After collecting the sample, 2:5 μl of 5 M ammonium acetate and 5 μl of 99:9% was added and mixed by pipetting. The mixture was kept at −20° C. overnight and the next day placed in a micro centrifuge at 4° C. and spun for 30 min at 14000 rpm. Typically, for purification of DNA, a small pellet containing the DNA is found at the bottom of the micro tube, but due to the very low amount of DNA was this invisible. The hinge portion of the tube was therefore oriented towards the centre of the micro centrifuge thus knowing where to expect the pellet. The supernatant was carefully pipped out of the chip thus leaving the DNA in 1-2 μl which was air dried. Finally, 2 μl of MilliQ water was added thus a 2.5 times higher concentration compared to the 5 μl was used to collect the DNA form the reservoir.

In order to determine the average concentration of the amplified ssDNA, a spectrophotometric analysis was performed. A spectrophotometric measurement of the MDA protocol of the collected material, a measurement of a MDA sample done off-chip with the identical protocol, and a measurement where the stating sample was without λ DNA but otherwise following the MDA protocol (negative amplification) were carried out.

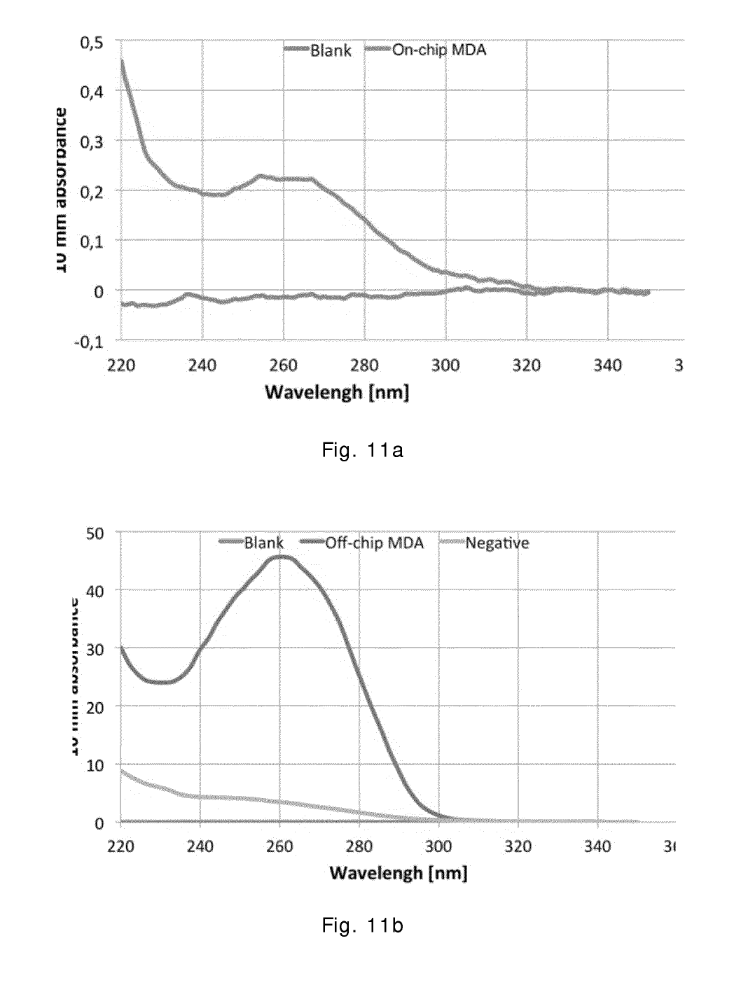

All measurement was done by pipetting 1 μl sample to the pedestal. The results from the off-chip amplification and the negative control are seen in FIG. 11 where the absorbance from the off-chip amplification shows a typical absorbance spectrum for DNA.

### LIST OF EMBODIMENTS

1. A microfluidic device for mixing liquid reagents, the device comprising, a chip forming at least one reaction chamber between a bottom and a top, the reaction chamber extending between an inlet for receiving the reagent and an outlet for discharging the reagent thereby forming a straight-line flow path in the chamber in a direction from the inlet to the outlet, characterized in that the device comprises a plurality of adjacent pillars, where each pillar forms its own axial direction extending from the bottom to the top, and where each pillar is separated from adjacent pillars by open slots.
2. A device according to embodiment 1, where the pillars are arranged to form at least one row extending in a row-direction being transverse to the straight-line flow path.
3. A device according to embodiment 1 or 2, comprising at least two rows each comprising a plurality of adjacent pillars, where adjacent pillars in a row are spaced at most a first distance, and where adjacent rows are spaced at least a second distance, the second distance being larger than the first distance.
4. A device according to any of the preceding embodiments, where at least one of the pillars connects the bottom wall to the top wall of the chamber.
5. A device according to any of the preceding embodiments, where the slots, in a cross section perpendicular to the axial direction of the pillars, are smaller than the pillars.
6. A device according to any of the preceding embodiments, where the pillars have a non-circular shape in a cross section perpendicular to the axial direction.
7. A device according to embodiment 6, where the non-circular shape forms at least one sharp pointed edge.
8. A device according to any of the preceding embodiments, where adjacent pillars are non-parallel.
9. A device according to any of the preceding embodiments, where each row extend non-parallel to at least one adjacent row.
10. A device according to embodiment 9, where flow sections formed by adjacent rows widens out in a flow direction along the rows from the inlet towards the outlet.
11. A device according to any of the preceding embodiments, where the inlet is configured to prevent diffusion of macromolecules including genomic DNA and enzymes in or out of the reaction chambers.
12. A device according to any of the preceding embodiments, where the inlet has a largest dimension in the same order of magnitude as the persistence length of double stranded DNA.
13. A device according to any of the preceding embodiments, where the chambers are located in a circular layout about a common junction, the inlets being in fluid communication with the common junction via micro channels.
14. A device according to any of the preceding embodiments, wherein the chip forms the reaction chambers, the inlets, the outlets, the common junction, and optionally the ports and the delivery conduits in one piece.
15. A device according to any of the preceding embodiments, where the chip is moulded in a polymeric material.
16. A device according to any of the preceding embodiments, where each chamber has at least one transparent or translucent wall section.
17. A method of mixing liquid reagents by use of a device according to any of embodiments 1-16, the method comprising providing a flow of the liquid reagents through the reaction chamber, where the flow speed is adjusted such that adjacent rows provides phase guiding of a meniscus of the reagents and such that subsequent flow of the liquid reagents are allowed to pass between adjacent pillars of a row.

1. A microfluidic device for mixing liquid reagents, the device comprising, a chip forming at least one reaction chamber between a bottom and a top, the reaction chamber extending between an inlet for receiving the reagent and an outlet for discharging the reagent thereby forming a straight-line flow path in the chamber in a direction from the inlet to the outlet, characterized in that the device comprises a plurality of adjacent pillars, where each pillar forms an axial direction extending from the bottom to the top, and where each pillar is separated from adjacent pillars by open slots.

2. The microfluidic device according to claim 1, where the pillars are arranged to form at least one row extending in a row-direction being transverse to the straight-line flow path.

3. The microfluidic device according to claim 2, comprising at least two rows each comprising a plurality of adjacent pillars, where adjacent pillars in a row are spaced at most a first distance, and where adjacent rows are spaced at least a second distance, the second distance being larger than the first distance.

4. The microfluidic device according to claim 1, where the pillars form a contact angle of at least 35 degrees to a fluid containing human DNA.

5. The microfluidic device according to claim 1, where the pillars are made from a hydrophobic material.

6. The microfluidic device according to claim 5, where the hydrophobic material is selected from a group consisting of: polypropylene, polyethylene , and amorphous polymer cyclic olefin copolymer materials.

7. The microfluidic device according to claim 1, where at least one of the pillars connects the bottom wall to the top wall of the chamber.

8. The microfluidic device according to claim 1, where the slots, in a cross section perpendicular to the axial direction of the pillars, are smaller than the pillars.

9. The microfluidic device according to claim 1, where the pillars have a non-circular shape in a cross section perpendicular to the axial direction.

10. The microfluidic device according to claim 9, where the non-circular shape forms at least one sharp pointed edge.

11. The microfluidic device according to claim 1, where adjacent pillars are non-parallel.

12. The microfluidic device according to claim 1, where each row extends non-parallel to at least one adjacent row.

13. The microfluidic device according to claim 12, where flow sections formed by adjacent rows widens out in a flow direction along the rows from the inlet towards the outlet.

14. The microfluidic device according to claim 1, where the inlet is configured to prevent diffusion of macromolecules including genomic DNA and enzymes in or out of the reaction chambers.

15. The microfluidic device according to claim 14, where the inlet has a largest dimension in the same order of magnitude as the persistence length of double stranded DNA.

16. The microfluidic device according to claim 1, where the chambers are located in a circular layout about a common junction, the inlets being in fluid communication with the common junction via micro channels.

17. The microfluidic device according to claim 1, wherein the chip forms the reaction chambers, the inlets, the outlets, the common junction, and optionally the ports and the delivery conduits in one piece.

18. A method of mixing liquid reagents by use of a device according to claim 1, the method comprising providing a flow of the liquid reagents through the reaction chamber, where the flow speed is adjusted such that adjacent rows provides phase guiding of a meniscus of the reagents and such that subsequent flow of the liquid reagents are allowed to pass between adjacent pillars of a row.

19. The method according to claim 18 where the liquid reagent comprises DNA.

20. The method according to claim 18, where the flow of the liquid reagent changes direction between rows of pillars.

21. The method according to claim 18, comprising the step of carrying out spectrophotometric analysis of the reagent in the device.

22. A method of making a device according to claim 1, where a polymer material is injected into a mould which is shaped such that the pillars supports the stability of the device and prevents deflection of the bottom and top towards each other.
